(19) United States
(12) Patent Application Publication
(10) Pub. No.: US 2003/0066979 A1
(43) Pub. Date: Apr. 10, 2003

(54) Plumbing connection system

(76) Inventor: George J. Maggio JR., Pembroke Pine, FL (US)

Correspondence Address: Larry G. Brown, Akerman Senterfitt, 222 Lakeview Avenue, Fourth Floor, P.O. Box 3188, West Palm Beach, FL, 33402-3188, US

(21) Appl. No.: 10/264,502

(22) Filed: Oct. 4, 2002

Related U.S. Application Data
(60) Provisional application No. 60/327,034, filed on Oct. 4, 2001.

(51) Int. Cl. F16L 29/00

(52) U.S. Cl. 251/148

(57) ABSTRACT

The invention concerns a system for providing fluid flow outlets having a flexible upper tubular member, a flexible lower tubular member and a connector for engaging the upper and lower tubular members such that the connector, the upper tubular member and the lower tubular member are in fluid communication with each other. Each of the upper tubular member and the lower tubular member is secured to the connector with at least one crimping fastener. In addition, the connector includes at least one outlet for supplying fluid to an external fluid receiving device. In one arrangement, the connector can include a valve for controlling the flow of fluid through the at least one outlet.

### CROSS-REFERENCE TO RELATED APPLICATIONS

(Not Applicable)

### STATEMENT REGARDING FEDERALLY SPONSORED RESEARCH OR DEVELOPMENT

(Not Applicable)

### BACKGROUND

1. Technical Field

The present invention relates generally to plumbing systems, and more particularly to a system for providing additional tap water outlets.

2. Description of Related Art

Currently, most homes contain water lines that connect the inlet line of a kitchen sink with an additional outlet such as an ice maker or a water purification device. Such an arrangement can expand the functionality of the kitchen sink inlet line. Notably, however, installation of such additional water lines can be tedious and time-consuming. For example, many homes have sinks that contain inlet lines made of metal such as copper that connect the hot and cold water inlet valves with the sink's faucets. To attach a separate line to such inlet lines, a plumber must remove a section from one of the inlet lines—typically the cold water inlet line—by cutting or sawing the inlet line at a suitable location. Once the section of inlet line is removed, the plumber attaches a connector to the remaining lines. The connector is typically secured to the remaining lines with several compression fittings and ferrels. The connector usually contains an outlet to which an auxiliary water line can be attached for purposes of delivering water to an additional outlet. Unfortunately, this means of attaching a connector to the remaining water lines consumes a lot of valuable work time and occasionally produces a faulty seal, as water may leak from any of the attachments.

Alternatively, a connector can be attached to the inlet line without removing any sections of pipe from the inlet line. In this particular arrangement, the connector contains an inlet for receiving water from the inlet line and an auxiliary water line for feeding water to an appropriate source. The connector can also have a semi-circular shaped clamp, which can wrap around a portion of the inlet line. The connector inlet is typically contained within the inner surface of the semi-circular shaped clamp. For purposes of attaching the connector to the inlet line, the connector contains one or more elongated screws with pointed tips, which can pierce the inlet line as they are turned. This piercing can create an opening through which water may flow from the inlet line to the auxiliary water line of the connector and on to the intended source.

There are also several significant drawbacks to this procedure as well. Namely, it may be awkward to obtain a proper fit between the connector and the inlet line. Moreover, even if a proper fitting is initially achieved, this fitting may deteriorate over time, as one or more of the internal components of the connector may corrode over time. Thus, what is needed is a plumbing connection system that overcomes the disadvantages of the prior art without increasing costs or creating the need for additional training to implement such a system.

### SUMMARY OF THE INVENTION

The present invention concerns a system for providing fluid flow outlets. The system includes a flexible upper tubular member, a flexible lower tubular member and a connector for engaging the upper and lower tubular members such that the connector, the upper tubular member and the lower tubular member are in fluid communication with each other. In addition, each of the upper tubular member and the lower tubular member is secured to the connector with at least one crimping fastener, and the connector includes at least one outlet for supplying fluid to an external fluid receiving device.

In one arrangement, the crimping fasteners can be constructed of a malleable material, and the connector can further include a valve for controlling the flow of fluid through the at least one outlet. The valve can be a needle valve. The connector can further include at least one grip having at least one substantially straight edge for receiving a plumbing tool. The system can also have a cap in which the cap can cover the at least one outlet when the outlet is not supplying fluid to the external fluid receiving device. In another arrangement, the system can include at least one self-sealing nut in which the self-sealing nuts can couple the upper tubular member to a faucet connection and the lower tubular member to a fluid inlet. The upper tubular member and the lower tubular member can be constructed of at least one of vinyl and plastic.

### BRIEF DESCRIPTION OF THE DRAWINGS

FIG. 1 illustrates a plumbing connection system in accordance with the inventive arrangements.

FIG. 2 illustrates an alternative arrangement of the plumbing connection system of FIG. 1 in accordance with the inventive arrangements.

### DETAILED DESCRIPTION OF THE PREFERRED EMBODIMENTS

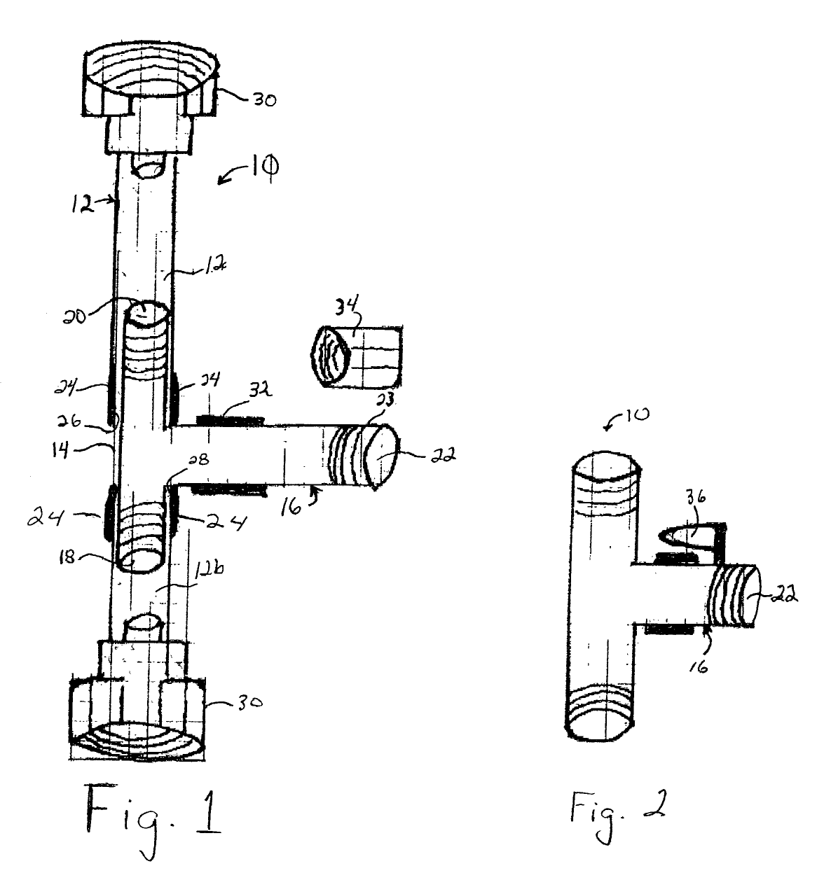

FIG. 1 illustrates a plumbing connection system 10 in accordance with the inventive arrangements. The plumbing connection system 10 can include a tube 12 having an upper tubular member 12a and a lower tubular member 12b. In addition, a gap 14 can be located between the upper tubular member 12a and the lower tubular member 12b. In one arrangement, the tube 12 can be constructed of flexible, reinforced vinyl or plastic suitable for receiving fluids. It should be noted, however, that the tube 12 is not limited in this regard, as the tube 12 can be constructed of any other suitable material.

The system 10 can also include a connector 16, which can have an inlet 18 and two outlets 20, 22. In one arrangement, the inlet 18 can be inserted into the lower tubular member 12b, and the outlet 20 can be inserted into the upper tubular member 12a such that the upper tubular member 12a, the lower tubular member 12b and the connector 16 can be in fluid communication with each other. The outlet 22 of the connector 16 can extend outwardly away from the gap 14. If desired, another tubular member (not shown) can be attached to this outlet 22 to permit water to flow to an external fluid receiving device (not shown), such as an ice maker or any other suitable device or component requiring a supply of fluid. Although FIG. 1 illustrates only one outlet 22 for providing a source of fluid to an external fluid receiving device, it is understood that the connector 16 can have any suitable number of such outlets 22.

In one embodiment, the upper tubular member 12a and the lower tubular member 12b can be secured to the outlet 20 and the inlet 18 respectively with one or more crimping fasteners 24. As pictured, the crimping fasteners 24 can be secured to an attaching end 26 of the upper tubular member 12a and to an attaching end 28 of the lower tubular member 12b. The crimping fasteners 24 are much easier to install and provide a better seal than the fasteners currently used in the industry. The crimping fasteners 24 are preferably constructed of a malleable material, such as a relatively thin metal, thereby permitting each of the fasteners 24 to be crimped or compressed against the outer surface of the attaching end 26 of the upper tubular member 12a and the outer surface of the attaching end 28 of the lower tubular member 12b.

In another arrangement, a self-sealing fitting nut 30 can be attached to the end of the upper tubular member 12a and to the end of the lower tubular member 12b to provide a means for coupling the system 10 to, for example, a water inlet (not shown) and a faucet connection (not shown). Further, the connector 16 can include one or more grips 32. As an example and as pictured in FIG. 1, the grip 32 can be a segment of the outlet 22 of the connector 16, which can contain one or more substantially straight edges (not pictured) to provide a suitable engaging area for a conventional plumbing tool such as a wrench. For purposes of the invention, the phrase “substantially straight” can mean true straight or slight or even moderate deviations therefrom. A plumbing tool can be used to connect the outlet 22 of the connector 16 to a tubular member for supplying fluid to an external fluid receiving device.

In one arrangement, the outlet 22 can have a threaded female end 23. The female end 23 of the outlet can receive and engage male threaded ends of a tubular member (not shown). In this arrangement, the system 10 can also include a cap 34, such as a compression cap, which can be threaded onto the threaded female end 23 of the outlet 22. The cap 34 permits a user to use the system 10 if no water is to be supplied to an external fluid receiving device. Of course, the invention is not limited to this particular configuration, as the outlet 22 can also have a male threaded end for receiving and engaging tubular members having female threaded ends. Additionally, those of ordinary skill in the art will appreciate that water is not the only fluid that may flow through the system 10, as the invention can be employed in any suitable fluid flow system.

Referring to FIG. 2, an alternative arrangement of the system 10 is shown. In this particular arrangement, the outlet 22 of the connector 16 can include a valve 36 for controlling the flow of fluid to an external fluid receiving device. Although FIG. 2 shows the valve 36 as a needle shut off valve, the invention is not limited in this regard, as the valve 36 can be any other component suitable for controlling the flow of fluid. As an example, placing a valve 36 in the outlet 22 enables the user to shut off the water supply to an external fluid receiving device without shutting off the cold water supply to the faucet of a basin.

It should be understood that the examples and embodiments described herein are for illustrative purposes only and that various modifications or changes in light thereof will be obvious to persons skilled in the art and are to be included within the spirit and purview of this application. Moreover, the invention can take other specific forms without departing from the spirit or essential attributes thereof.

What is claimed is:

1. A system for providing fluid flow outlets, comprising:
a flexible upper tubular member;
a flexible lower tubular member; and
a connector for engaging said upper and lower tubular members such that said connector, said upper tubular member and said lower tubular member are in fluid communication with each other;
wherein each of said upper tubular member and said lower tubular member is secured to said connector with at least one crimping fastener;
wherein said connector includes at least one outlet for supplying fluid to an external fluid receiving device.

2. The system according to claim 1, wherein said crimping fasteners are constructed of a malleable material.

3. The system according to claim 1, wherein said connector further includes a valve for controlling the flow of fluid through said at least one outlet.

4. The system according to claim 3, wherein said valve is a needle valve.

5. The system according to claim 1, wherein said connector further includes at least one grip having at least one substantially straight edge for receiving a plumbing tool.

6. The system according to claim 1, further comprising a cap, wherein said cap covers said at least one outlet when said outlet is not supplying fluid to the external fluid receiving device.

7. The system according to claim 1, further comprising at least one self-sealing nut, wherein said self-sealing nuts couple said upper tubular member to a faucet connection and said lower tubular member to a fluid inlet.

8. The system according to claim 1, wherein said upper tubular member and said lower tubular member are constructed of at least one of vinyl and plastic.
